(19) United States
(12) Patent Application Publication
(10) Pub. No.: US 2025/0044670 A1
(43) Pub. Date: Feb. 6, 2025

(54) ROTATING SHOOTING BRACKET FOR 360-DEGREE PHOTO BOOTH

(71) Applicant: Shenzhen Vanplex Co., Ltd, Shenzhen (CN)

(72) Inventor: Hongwen Lv, Shenzhen (CN)

(21) Appl. No.: 18/920,571

(22) Filed: Oct. 18, 2024

(30) Foreign Application Priority Data
Sep. 11, 2024 (CN) 202422228894.1

(51) Int. Cl. G03B 17/56; F16M 11/04; F16M 11/20; G03B 15/00

(52) U.S. Cl. CPC G03B 17/561; F16M 11/046; F16M 11/2014; F16M 2200/027; F16M 2200/06; G03B 15/00

(57) ABSTRACT

Provided is a rotating shooting bracket for a 360-degree photo booth, including a rotating connecting rod extending into an inner side of a photo booth part, and a telescopic rod assembly rotatably and movably connected to one end of the rotating connecting rod. The telescopic rod assembly includes multiple telescopic rod units connected end to end, and a connecting part of the rotating connecting rod and the telescopic rod assembly is provided with a stepless adjusting plate. A stepless adjusting hole is formed in the stepless adjusting plate. The rotating shooting bracket further includes a locking switch for locking one end of the telescopic rod assembly onto the stepless adjust plate, and a locking connecting rod penetrating through the stepless adjusting hole.

### TECHNICAL FIELD

The present disclosure relates to the technical field of rotating photo booth products, and in particular to a rotating shooting bracket for a 360-degree photo booth with high humanization degree and high experience degree.

### BACKGROUND

With the continuous improvement of living standards of people, entertainment equipment is also more colorful. In recent years, the 360-degree photo booth for 360-degree surrounding photography has been widely welcomed by consumers. The 360-degree photo booth, also known as 360 photo booth, is a platform for 360-degree shooting, which, compared with ordinary self-timer products, has a further entertainment experience in terms of application effect. Moreover, through such an apparatus, a photographed subject can stand on the supporting table and is photographed by rotating the rotatable shooting bracket, and the experience and the interest of shooting of the user are greatly enriched in actual use.

The structural construction of the existing photo booth products is mainly formed by connecting the supporting stage, the supporting base, internal driving components and a shooting bracket capable of rotating 360 degrees by a central shaft in the middle. During the event, 3-6 people or more can stand on the supporting stage, and then multi-angle surrounding shooting can be achieved in conjunction with the shooting of the shooting bracket. However, the shooting bracket in the prior art generally employs an adjusting structure with a fixed angle, the rod element is unable to extend and retract flexibly, such that the practical use requirements cannot be better met, and the experience is poor.

For example, in the invention patent with the patent number of CN202221031966.8 and entitled “360-degree camera device having atmosphere lamp”, a 360-degree camera device having atmosphere lamp is provided, including a supporting stage, a supporting spindle, a supporting base and a rotating shooting bracket. The supporting stage includes a first supporting element, tempered glass, a first light source, and a reflecting mirror. The first supporting element is used for supporting the tempered glass. The tempered glass is single-sided perspective glass including a light-transmitting surface and a reflecting surface. An interval area is arranged between the tempered glass and the reflecting mirror. The reflecting mirror and the reflecting surface are oppositely arranged. The first light source is disposed in the interval area. The first light source is in a shape of graphics and/or characters. The first light source includes a plurality of point-shaped light-emitting parts, and the first light source is substantially arranged in an annular shape and arranged along edge contour of the tempered glass or the reflecting mirror. The supporting stage includes a second supporting element, the second supporting element is used for supporting a central position of the tempered glass, and the first supporting element is used for supporting an edge position of the tempered glass.

In the above prior art patent document, the shooting bracket structure with preset angle adjusting interval is adopted (referring to FIG. 1 in this specification), and the rod element is unable to extend and retract and be limited flexibly, flexibly extended and limited, which affects the actual use.

Therefore, the structure of the prior art needs to be improved to further improve the experience degree and practicability of the 360-degree photo booth.

### SUMMARY

The problem in the prior art solved by the present disclosure is as follows.

The structural construction of the existing photo booth products is mainly formed by connecting the supporting stage, the supporting base, internal driving components and a shooting bracket capable of rotating 360 degrees by a central shaft in the middle. During the event, 3-6 people or more can stand on the supporting stage, and then multi-angle surrounding shooting can be achieved in conjunction with the shooting of the shooting bracket. However, the shooting bracket in the prior art generally employs an adjusting structure with a fixed angle, the rod element is unable to extend and retract flexibly, such that the practical use requirements cannot be better met, and the experience is poor.

The solution adopted by the present disclosure for solving the technical problem is as follows:

A rotating shooting bracket for a 360-degree photo booth includes a rotating connecting rod extending into an inner side of a photo booth part, and a telescopic rod assembly rotatably and movably connected to one end of the rotating connecting rod. The telescopic rod assembly includes multiple telescopic rod units connected end to end.

A connecting part of the rotating connecting rod and the telescopic rod assembly is provided with a stepless adjusting plate, and a stepless adjusting hole is formed in the stepless adjusting plate.

The rotating shooting bracket further includes a locking switch for locking one end of the telescopic rod assembly onto the stepless adjust plate, and a locking connecting rod penetrating through the stepless adjusting hole.

One end of the locking connecting rod is in fit connection with the locking switch, and the other end of the locking connecting rod is in fit connection with one end of the telescopic rod assembly.

Preferably, the telescopic rod assembly further includes a clamping sleeve for limiting and maintaining a telescopic state of each telescopic rod unit.

The clamping sleeve includes a first clamping portion and a second clamping portion which are in fit connection with two adjacent telescopic rod units, respectively.

The telescopic rod assembly further includes a clamping switch for clamping and adjusting the first clamping portion and/or the second clamping portion.

Preferably, the stepless adjusting hole is in the shape of a circular arc.

The rotating shooting bracket further includes a rotating shaft arranged on the stepless adjusting plate.

One end of the telescopic rod assembly is provided with a rotating hole for connecting the rotating shaft, and a locking connecting hole for connecting the locking connecting rod.

Preferably, the stepless adjusting plate is fixedly arranged at an end part of the rotating connecting rod.

A lower portion of the stepless adjusting plate is integrally formed with or connected with a connecting bottom plate for being connected to the rotating connecting rod.

Preferably, the locking connecting rod is a screw.

The locking switch is fixedly connected to one end of the locking connecting rod, and the locking connecting hole is a threaded hole for the locking connecting rod to pass through.

The locking switch is provided with a threaded connecting portion threaded to one end of the locking connecting rod, and the locking connecting hole of the telescopic rod assembly is used for rotating and limiting one end of the locking connecting rod.

Preferably, one end, located at the locking connecting hole, of the locking connecting rod is provided with a nut.

The locking connecting hole is a hole structure in fit with the shape of the nut, and the nut is accommodated into the hole structure.

Preferably, the first clamping portion is integrally formed with a first clamping pillar in fit connection with the clamping switch.

The clamping switch includes an operation portion, and a clamping portion connected to the operation portion.

The first clamping pillar is provided with a clamping through hole for penetrating through the clamping portion, and the operation portion is located outside the clamping through hole.

The second clamping portion is integrally formed with a second clamping pillar.

Preferably, the clamping portion is a screw, and the operation portion is a rotating knob connected to the clamping portion.

Preferably, a fixed limit screw is arranged on the second clamping pillar in a penetrating manner, and a fixed limit nut is arranged on the fixed limit screw.

Preferably, the first clamping portion and the second clamping portion are of an integrally formed structure.

The technical effects produced by solving the technical problem by the present disclosure are as follows:

Compared with the prior art, a rotating shooting bracket for a 360-degree photo booth is provided with a rotating connecting rod 14 extending into an inner side of a photo booth part and a telescopic rod assembly 11 rotatably and movably connected to one end of the rotating connecting rod 14. The telescopic rod assembly 11 includes multiple telescopic rod units which are connected end to end, and a connecting part of the rotating connecting rod 14 and the telescopic rod assembly 11 is provided with a stepless adjusting plate 13. A stepless adjusting hole 131 is formed in the stepless adjusting plate 13. The rotating shooting bracket further includes a locking switch 15 for locking one end of the telescopic rod assembly 11 onto the stepless adjust plate 13, and a locking connecting rod 112 penetrating through the stepless adjusting hole 13. One end of the locking connecting rod 112 is in fit connection with the locking switch 15, and the other end of the locking connecting rod is in fit connection with one end of the telescopic rod assembly 11. During practical application, the flexible adjustment of any angle of the shooting bracket can be better achieved, and a problem that only fixed angle adjustment can be made due to the adoption of a fixed limit hole in the traditional design is improved.

### BRIEF DESCRIPTION OF THE DRAWINGS

FIG. 1 is a schematic structural diagram of a three-dimensional state of a rotating shooting bracket for a 360-degree photo booth according to the present disclosure;

FIG. 2 is a schematic structural diagram of an explosive state of a rotating shooting bracket for a 360-degree photo booth according to the present disclosure.

FIG. 3 is a schematic structural diagram of a partial enlarged state of a rotating shooting bracket for a 360-degree photo booth according to the present disclosure.

### DETAILED DESCRIPTION OF THE EMBODIMENTS

In order to make the objectives, technical solutions and advantages of the present disclosure more clearly, the present disclosure is further described in detail below with reference to the accompanying drawings and embodiments.

It should be understood that specific embodiments described here are only used to illustrate rather than limiting the present disclosure.

All other embodiments obtained by those of ordinary skill in the art based on the embodiments of the present disclosure without creative efforts shall fall within the scope of protection of the present disclosure.

It should be noted that when an assembly is said to be “fixed” to another assembly, it can be directly on another assembly or there may be an intervening assembly. When an assembly is said to be “connected” to another assembly, it can be directly connected to another assembly or there may be an intervening assembly.

Unless otherwise defined, all technical and scientific terms used herein have the same meaning as commonly understood by those skilled in the art of the present disclosure.

The terminology used in the description of the present disclosure herein is only for the purpose of describing specific embodiments and is not intended to limit the present disclosure. It may be understood that the term “and/or” used herein refers to and covers any and all possible combinations of one or more of the associated listed items.

Some embodiments of the present disclosure are further described below in detail with reference to the accompanying drawings. It should be noted that the following embodiments and features in the embodiments may be combined with each other without causing conflict.

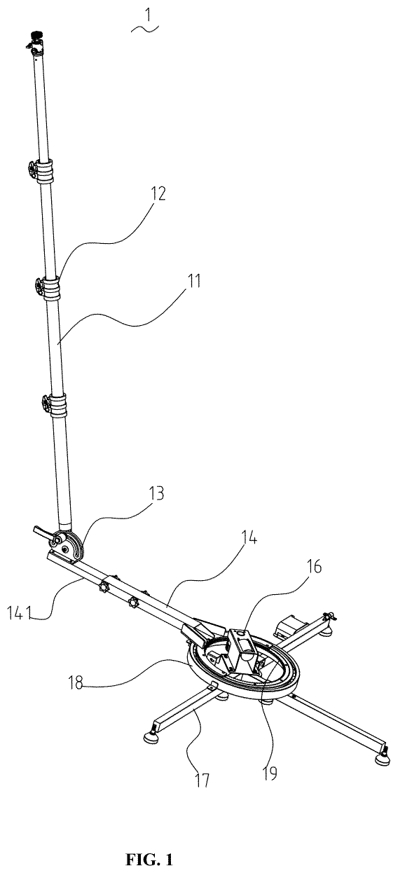

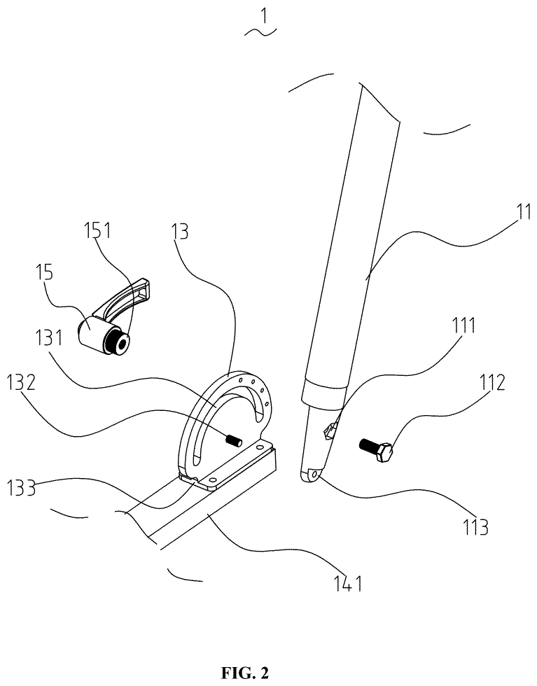

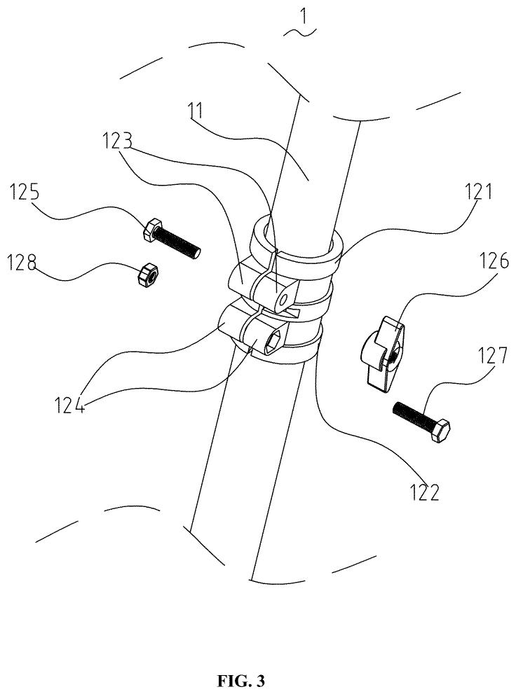

Please referring to FIG. 1 to FIG. 3, a rotating shooting bracket 1 for a 360-degree photo booth includes a rotating connecting rod 14 extending into an inner side of a photo booth part, a telescopic rod assembly 11 rotatably and movably connected to one end of the rotating connecting rod 14. The telescopic rod assembly 11 includes multiple telescopic rod units connected end to end.

A specific telescopic limit structure of the telescopic rod assembly 11 may employ multiple different ways, and the length of the rod element is adjusted by rotating and folding, which also belongs to the equivalent technical solutions means. The basically same means are used to solve the basically same technical problems and achieve the basically same technical effects.

A connecting part of the rotating connecting rod 14 and the telescopic rod assembly 11 is provided with a stepless adjusting plate 13, and a stepless adjusting hole 131 is formed in the stepless adjusting plate 13.

The rotating shooting bracket further includes a locking switch 15 for locking one end of the telescopic rod assembly 11 onto the stepless adjusting plate 13, and a locking connecting rod 112 penetrating through the stepless adjusting hole 131.

One end of the locking connecting rod 112 is in fit connection with the locking switch 15, and the other end of the locking connecting rod 112 is in fit connection with one end of the telescopic rod assembly 11.

According to the present disclosure, a rotating connecting rod 14 extending into an inner side of a photo booth part and a telescopic rod assembly 11 rotatably and movably connected to one end of the rotating connecting rod 14 are provided at the same time. The telescopic rod assembly 11 includes multiple telescopic rod units which are connected end to end, and a connecting part of the rotating connecting rod 14 and the telescopic rod assembly 11 is provided with a stepless adjusting plate 13. A stepless adjusting hole 131 is formed in the stepless adjusting plate 13. The rotating shooting bracket further includes a locking switch 15 for locking one end of the telescopic rod assembly 11 onto the stepless adjust plate 13, and a locking connecting rod 112 penetrating through the stepless adjusting hole 13. One end of the locking connecting rod 112 is in fit connection with the locking switch 15, and the other end of the locking connecting rod is in fit connection with one end of the telescopic rod assembly 11. During practical application, the flexible adjustment of any angle of the shooting bracket can be better achieved, and a problem that only fixed angle adjustment can be made due to the adoption of a fixed limit hole in the traditional design is improved.

In some other embodiments, the telescopic rod assembly 11 further includes a clamping sleeve 12 for limiting and maintaining a telescopic state of each telescopic rod unit.

The clamping sleeve 12 is generally made of plastic, PE (polyethylene), or other materials, such that the clamping sleeve 12 can be deformed properly during practical use to facilitate the clamping, extension and retraction of the rod element.

The clamping sleeve 12 includes a first clamping portion 121 and a second clamping portion 122 which are in fit connection with two adjacent telescopic rod units, respectively.

The telescopic rod assembly 11 further comprises a clamping switch for clamping and adjusting the first clamping portion 121 and/or the second clamping portion 122.

The stepless adjusting hole 131 is in the shape of a circular arc to facilitate the rotation of the telescopic rod assembly 11.

The rotating shooting bracket further includes a rotating shaft 132 arranged on the stepless adjusting plate 13.

One end of the telescopic rod assembly 11 is provided with a rotating hole 113 for connecting the rotating shaft 132, and a locking connecting hole 111 for connecting the locking connecting rod 112.

The stepless adjusting plate 13 is fixedly arranged at an end part of the rotating connecting rod 14.

A lower portion of the stepless adjusting plate 13 is integrally formed with or connected with a connecting bottom plate 133 for being connected to the rotating connecting rod 14. The locking connecting rod 112 is a screw.

The locking switch 15 is fixedly connected to one end of the locking connecting rod 112, and the locking connecting hole 111 is a threaded hole for the locking connecting rod 112 to pass through.

Alternatively, the locking switch 15 is provided with a threaded connecting portion 151 threaded to one end of the locking connecting rod 112, and the locking connecting hole 111 of the telescopic rod assembly 11 is used for rotating and limiting one end of the locking connecting rod 112.

One end, located at the locking connecting hole 111, of the locking connecting rod 112 is provided with a nut.

The locking connecting hole is of a hole structure in fit with the shape of the nut, and the nut is accommodated into the hole structure.

The first clamping portion 121 is integrally formed with a first clamping pillar 123 in fit connection with the clamping switch.

The clamping switch includes an operation portion 126, and a clamping portion 125 connected to the operation portion 126.

The first clamping pillar 123 is provided with a clamping through hole for penetrating through the clamping portion 125, and the operation portion 126 is located outside the clamping through hole.

The second clamping portion 122 is integrally formed with a second clamping pillar 124.

The clamping portion 125 is a screw, and the operation portion 126 is a rotating knob connected to the clamping portion 125.

A fixed limit screw rod 127 is arranged on the second clamping pillar 124 in a penetrating manner, and a fixed limit nut 128 is arranged on the fixed limit screw rod 128. The first clamping portion 121 and the second clamping portion 122 are of an integrally formed structure.

The technical effects produced by solving the technical problem by the present disclosure are as follows:

Compared with the prior art, a rotating shooting bracket for a 360-degree photo booth is provided with a rotating connecting rod 14 extending into an inner side of a photo booth part and a telescopic rod assembly 11 rotatably and movably connected to one end of the rotating connecting rod 14. The telescopic rod assembly 11 includes multiple telescopic rod units which are connected end to end, and a connecting part of the rotating connecting rod 14 and the telescopic rod assembly 11 is provided with a stepless adjusting plate 13. A stepless adjusting hole 131 is formed in the stepless adjusting plate 13. The rotating shooting bracket further includes a locking switch 15 for locking one end of the telescopic rod assembly 11 onto the stepless adjust plate 13, and a locking connecting rod 112 penetrating through the stepless adjusting hole 13. One end of the locking connecting rod 112 is in fit connection with the locking switch 15, and the other end of the locking connecting rod is in fit connection with one end of the telescopic rod assembly 11. During practical application, the flexible adjustment of any angle of the shooting bracket can be better achieved, and a problem that only fixed angle adjustment can be made due to the adoption of a fixed limit hole in the traditional design is improved.

The above is only the embodiments of the present disclosure, and the scope of protection of the present disclosure is not limited to the above embodiments. Any modification, equivalent replacement, improvement, etc. made within the spirit and principle of the present disclosure should be included in the scope of protection of the present disclosure.

What is claimed is:

1. A rotating shooting bracket for a 360-degree photo booth, comprising a rotating connecting rod extending into an inner side of a photo booth part, and a telescopic rod assembly rotatably and movably connected to one end of the rotating connecting rod, wherein the telescopic rod assembly comprises a plurality of telescopic rod units connected end to end;
a connecting part of the rotating connecting rod and the telescopic rod assembly is provided with a stepless adjusting plate, and a stepless adjusting hole is formed in the stepless adjusting plate;
the rotating shooting bracket further comprises a locking switch for locking one end of the telescopic rod assembly onto the stepless adjust plate, and a locking connecting rod penetrating through the stepless adjusting hole; and
one end of the locking connecting rod is in fit connection with the locking switch, and the other end of the locking connecting rod is in fit connection with one end of the telescopic rod assembly.

2. The rotating shooting bracket for a 360-degree photo booth according to claim 1, wherein the telescopic rod assembly further comprises a clamping sleeve for limiting and maintaining a telescopic state of each telescopic rod unit;
the clamping sleeve comprises a first clamping portion and a second clamping portion which are in fit connection with two adjacent telescopic rod units, respectively; and
the telescopic rod assembly further comprises a clamping switch for clamping and adjusting the first clamping portion and/or the second clamping portion.

3. The rotating shooting bracket for a 360-degree photo booth according to claim 1, wherein the stepless adjusting hole is in the shape of a circular arc;
the rotating shooting bracket further comprises a rotating shaft arranged on the stepless adjusting plate; and
one end of the telescopic rod assembly is provided with a rotating hole for connecting the rotating shaft, and a locking connecting hole for connecting the locking connecting rod.

4. The rotating shooting bracket for a 360-degree photo booth according to claim 3, wherein the stepless adjusting plate is fixedly arranged at an end part of the rotating connecting rod
a lower portion of the stepless adjusting plate is integrally formed with or connected with a connecting bottom plate for being connected to the rotating connecting rod.

5. The rotating shooting bracket for a 360-degree photo booth according to claim 3, wherein the locking connecting rod is a screw;
the locking switch is fixedly connected to one end of the locking connecting rod, and the locking connecting hole is a threaded hole for the locking connecting rod to pass through; or
the locking switch is provided with a threaded connecting portion threaded to one end of the locking connecting rod, and the locking connecting hole of the telescopic rod assembly is used for rotating and limiting one end of the locking connecting rod.

6. The rotating shooting bracket for a 360-degree photo booth according to claim 5, wherein one end, located at the locking connecting hole, of the locking connecting rod is provided with a nut; and
the locking connecting hole is a hole structure in fit with the shape of the nut, and the nut is accommodated into the hole structure.

7. The rotating shooting bracket for a 360-degree photo booth according to claim 2, wherein the first clamping portion is integrally formed with a first clamping pillar in fit connection with the clamping switch;
the clamping switch comprises an operation portion, and a clamping portion connected to the operation portion;
the first clamping pillar is provided with a clamping through hole for penetrating through the clamping portion, and the operation portion is located outside the clamping through hole; and
the second clamping portion is integrally formed with a second clamping pillar.

8. The rotating shooting bracket for a 360-degree photo booth according to claim 2, wherein the clamping portion is a screw, and the operation portion is a rotating knob connected to the clamping portion.

9. The rotating shooting bracket for a 360-degree photo booth according to claim 7, wherein a fixed limit screw is arranged on the second clamping pillar in a penetrating manner, and a fixed limit nut is arranged on the fixed limit screw.

10. The rotating shooting bracket for a 360-degree photo booth according to claim 2, wherein the first clamping portion and the second clamping portion are of an integrally formed structure.
